(19) United States
(12) Patent Application Publication
(10) Pub. No.: US 2021/0172534 A1
(43) Pub. Date: Jun. 10, 2021

(54) VALVE

(71) Applicant: Vitesco Technologies GmbH, Hannover (DE)

(72) Inventors: Stefan Oskar GRÜNEIS, Schwalbach a. Ts. (DE); Rosario BONANNO, Schwalbach a. Ts. (DE)

(21) Appl. No.: 16/771,134

(22) PCT Filed: Dec. 17, 2018
(86) PCT No.: PCT/EP2018/085245

§ 371 Date: Jun. 9, 2020

(30) Foreign Application Priority Data
Dec. 20, 2017 (DE) 10 2017 223 313.3

(51) Int. Cl. F16K 1/46; F16K 31/06; F16K 27/02

(52) U.S. Cl. CPC F16K 1/46; F16K 27/029; F16K 31/0655

(57) ABSTRACT

A valve having a housing, a solenoid arranged in the housing, a pin movable by the solenoid, a pot-shaped piston connected to the pin, a seal that seals off the piston against the housing, and a seal that seals off the piston against a valve seat. The piston has on the side facing the housing and on the side facing the valve seat one radially encircling receiving part, in which one seal is arranged.

### CROSS REFERENCE TO RELATED APPLICATIONS

This is a U.S. national stage of Application No. PCT/EP2018/085245 filed Dec. 17, 2018. Priority is claimed on German Application No. DE 10 2017 223 313.3 filed Dec. 20, 2017 the content of which is incorporated herein by reference.

### BACKGROUND OF THE INVENTION

### 1. Field of the Invention

The invention relates to a valve having a housing, a solenoid arranged in the housing, a pin movable by the solenoid, a pot-shaped piston connected to the pin, a seal that seals off the piston against the housing, and a seal that seals off the piston against a valve seat.

### 2. Description of Related Art

Valves are used, inter alia, as a diverter valve on a turbocharger in motor vehicles to open a bypass to a suction side in overrun operation, and are thus known. To prevent excessive deceleration of the turbocharger and to ensure a fast start-up, rapid opening, and closing of the valve are essential prerequisites. During the closing process, immediate closure as a result of the abutment of the piston against a valve seat is of importance. The valve seat is formed by the housing of the turbocharger, on which the valve is flange-mounted. Here, the axially displaceable piston is sealed off against the housing. The sealing is realized via a seal. Such seals often have a V-shaped cross section, with the limbs of the V being formed as sealing lips. For sealing of the piston against the valve seat, it is known to form the base of the piston with a radially encircling sealing edge. A disadvantage is that the piston and the V-shaped seal are relatively complex components, which are associated with cumbersome manufacture and accordingly entail high costs. Simpler solutions, on the other hand, have higher leakage values.

### SUMMARY OF THE INVENTION

One aspect of the invention is a valve that makes possible simple sealing of the piston against the housing. The valve should furthermore be inexpensive.

One aspect of the invention is that the piston has, on the side facing the housing and on the side facing the valve seat, one radially encircling receiving part in which one seal is arranged. The receiving parts on the piston permit simple arrangement of the seals. Elaborate holding elements or clamps of the seals can thus be dispensed with. A further simplification is provided by the arrangement of the seals on the piston since all the seals can be fitted completely on the piston. The piston can thus be connected as a preassembled part to the valve, which facilitates the assembly.

A particularly simple and reliable arrangement of the seals is provided if, according to one aspect of the invention, the receiving parts are formed as beads. Beads have the advantage that they can be produced easily, and so the piston is also of simple construction. Additional securing elements for the securing of the position of the seals are not required.

Due to the receiving parts on the piston, a further configuration is to use the disk-shaped seals and/or O-rings as seals. The seals have a simple construction. Such a valve is particularly inexpensive.

In another configuration, good sealing action is achieved in that the seals consist of a plastic or an elastomer.

The seals can be easily fitted as separate components on the piston. An improved fit of the seals is however achieved in that the seals are injection molded as a plastic seal on the piston or are vulcanized as an elastomer seal thereon.

According to one aspect of the invention, the construction of the valve can be further simplified, and thus made more inexpensive, if the pot-shaped piston has a base that is inserted as a separate component into the piston. With this two-part design of the piston, the beads can be introduced into the cylindrical lateral surface of the piston in one working step.

For a secure and stable connection of the base to the piston, said base is welded or soldered to the cylindrical lateral surface. A further simplification with the production is provided if the base is pressed together with the piston.

### BRIEF DESCRIPTION OF THE DRAWINGS

The invention will be described in more detail on the basis of an exemplary embodiment. In the figures:

FIG. 1 is a sectional illustration of a valve according to the prior art;

FIG. 2 is a sectional illustration of the valve according to the invention; and

FIG. 3 is an enlarged illustration of the piston.

### DETAILED DESCRIPTION OF THE PRESENTLY PREFERRED EMBODIMENTS

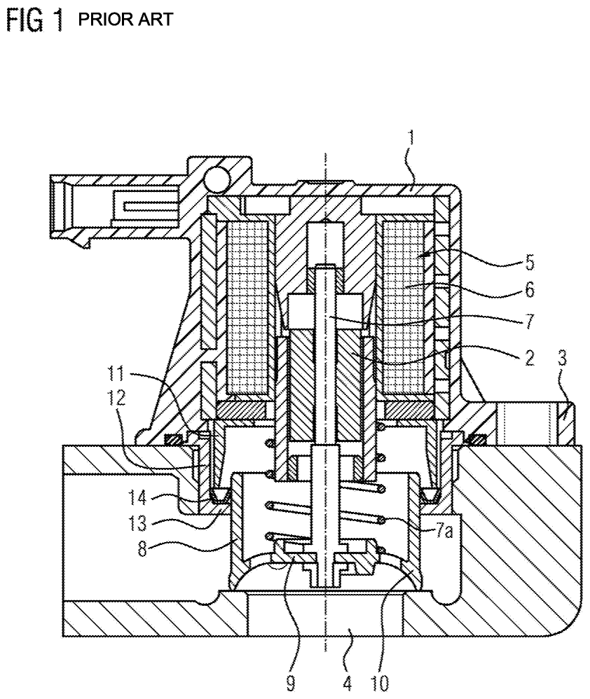

FIG. 1 shows a valve, which comprises a housing 1. The housing 1 has an integrally formed flange 3, via which the housing 1 is flange-mounted on a turbocharger (not illustrated) in the region of a bypass line 4. In the housing 1, there is arranged a solenoid 5 with a coil 6 and a metal pin 7. The metal pin 7 is connected to a pot-shaped piston 8 which, at the periphery of its base 9, has a seal 10. Here, a spring 7a pushes the piston 8 in the direction of the valve seat.

The housing 1 has a cylindrical section 11 that extends in the direction of the piston 8. A cylinder bushing 12 connected to the housing surrounds the cylindrical section 11. The cylinder bushing 12 has a radially inwardly directed collar 13, on which a V-shaped seal 14 abuts. The end of the cylindrical section 11 holds the seal 14 in position. The inner limb of the seal 14 seals off the piston 8 against the housing 1. If the solenoid 5 is electrically energized, a magnetic force acts on the armature 2, whereby the piston 8 is moved in the direction of the housing 1. Here, the seal 14 seals off the piston 8 against the housing 1.

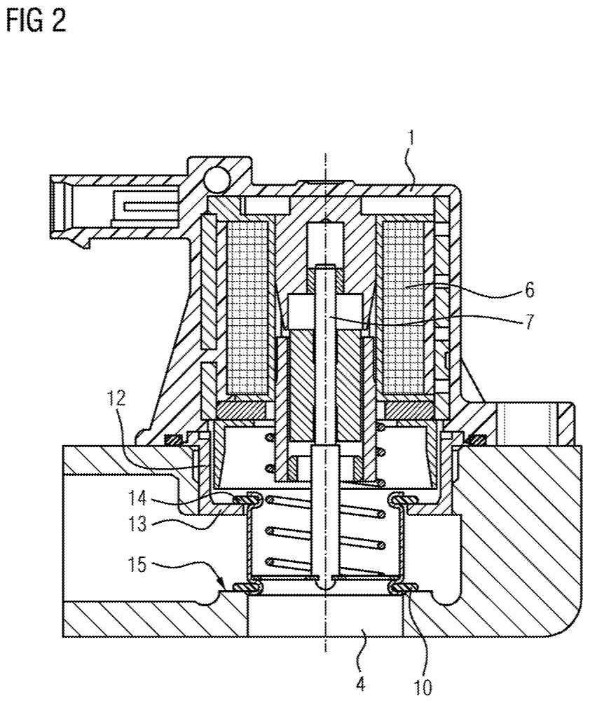

The valve according to one aspect of the invention in FIG. 2 has a pot-shaped piston 8, which is described in more detail below. A seal 14 seals off the piston 8 against the housing 1 in that the seal 14, in the closed state of the valve, abuts on the collar 13 of the cylinder bushing 12. The seal 10 abuts against the valve seat 15 and closes off the bypass line 4.

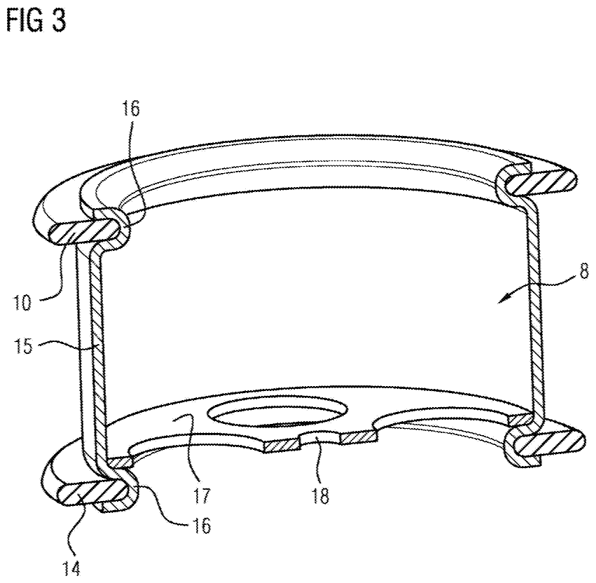

The piston 8 in FIG. 3 has a cylindrical lateral surface 15, at the ends of which in each case one bead 16 is formed. In each bead 16, in each case one disk-shaped seal 10, 14 composed of polytetrafluoroethylene is injection molded. A disk-shaped base 17 is welded above the seal 10 to the cylindrical lateral surface 15. However, it is also conceivable for the base 17 to be arranged below the seal 10. A central bore 18 in the base serves for receiving the pin 7, which is connected to the piston by means of a rivet connection.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A valve comprising:
a housing;
a solenoid arranged in the housing;
a pin configured to be moved by the solenoid;
a piston that is pot-shaped and connected to the pin;
a first seal that seals off the piston against the housing;
a second seal that seals off the piston against a valve seat; and
one respective radially encircling receiving part in the piston on the side facing the housing and on the side facing the valve seat and configured to receive the first seal and the second seal.

10. The valve as claimed in claim 9, wherein the respective radially encircling receiving parts are beads.

11. The valve as claimed in claim 10, wherein at least one of the first seal and the second seal is a disk-shaped seal and/or an O-ring.

12. The valve as claimed in claim 11, wherein at least one of first seal and the second seal is plastic or an elastomer.

13. The valve as claimed in claim 12, wherein at least one of the first seal and the second seal is injection molded or vulcanized on the piston.

14. The valve as claimed in claim 9, wherein a base of the piston is inserted into the piston as a separate component.

15. The valve as claimed in claim 14, wherein the base is welded or soldered to the piston.

16. The valve as claimed in claim 14, wherein the base is pressed together with the piston.
